(19) United States
(12) Patent Application Publication
(10) Pub. No.: US 2026/0093780 A1
(43) Pub. Date: Apr. 2, 2026

(54) CONTINUAL LEARNING METHOD AND DEVICE FOR MULTIMODALITY DATA

(71) Applicant: CHUNG ANG UNIVERSITY INDUSTRY ACADEMIC COOPERATION FOUNDATION, Seoul (KR)

(72) Inventors: EUN WOO KIM, Seoul (KR); HYUN DONG JIN, Seoul (KR)

(21) Appl. No.: 19/342,909

(22) Filed: Sep. 29, 2025

(30) Foreign Application Priority Data
Sep. 30, 2024 (KR) 10-2024-0133343

(51) Int. Cl. G06F 18/22; G06F 18/2135; G06F 40/284; G06N 3/084

(52) U.S. Cl. CPC G06F 18/22; G06F 18/21355; G06F 40/284; G06N 3/084

(57) ABSTRACT

A continual learning method includes receiving multimodality data including data items having modalities and tokenizing each data, receiving text data representing a class for the multimodality data and tokenizing the text data, generating an aggregated modality prompt, generating an aggregated text prompt, inputting modality concatenation data, in which the aggregated modality prompt is concatenated with the tokenized multimodality data, into a vision encoder and outputting a modality embedding vector, inputting text concatenation data in which the aggregated text prompt is concatenated with the tokenized text data into a language encoder and outputting a text embedding vector, and projecting the text embedding vector into an embedding space through a projection head of the language encoder and projecting the modality embedding vector into the embedding space through a projection head of the vision encoder so that the modality embedding vector and the text embedding vector that correspond to each other are matched.

### CROSS-REFERENCE TO RELATED APPLICATION AND CLAIM OF PRIORITY

This application claims the benefit under 35 USC § 119 (a) of Korean Patent Application No. 10-2024-0133343 filed on Sep. 30, 2024 in the Korean Intellectual Property Office, the entire disclosure of which is incorporated herein by reference for all purposes.

### BACKGROUND

### 1. Field

The present disclosure relates to a continual learning method and device for multimodality data.

### 2. Description of Related Art

Since a deep learning model overwrites previously learned knowledge when accepting new information, a problem arises in that the previously learned knowledge is forgotten. This problem is known as catastrophic forgetting.

In order to alleviate this problem of catastrophic forgetting, continual learning methods seek to preserve existing knowledge while accepting new information. To this end, in order to minimize changes in key parameters that contribute to performance in a previous task, the methods apply a penalty loss or distill knowledge of a previous model into a new model.

However, the methods for minimizing the changes in parameters that contribute to the performance of the previous task may result in a large loss of learned knowledge when domains between tasks are different and as the number of tasks increases. Accordingly, there is a need for a method for continual learning capable of preserving previously learned knowledge while using multimodality data.

Examples of the related art include Korean Patent Laid-Open Publication No. 10-2024-0002813 and Korean Patent Laid-Open Publication No. 10-2024-0100242.

### SUMMARY

Accordingly, the present disclosure is directed to providing a multimodality continual learning method and device capable of alleviating the catastrophic forgetting phenomenon that occurs while training on modality data.

In one general aspect, there is provided a continual learning method performed in a computing device including one or more processors and a memory storing one or more programs executed by the one or more processors, including receiving multimodality data including a plurality of data items having different modalities and tokenizing each piece of data, receiving text data representing a class for the multimodality data and tokenizing the text data, generating an aggregated modality prompt for the multimodality data, generating an aggregated text prompt for the text data; inputting modality concatenation data, in which the aggregated modality prompt is concatenated with the tokenized multimodality data, into a vision encoder and outputting a modality embedding vector, inputting text concatenation data in which the aggregated text prompt is concatenated with the tokenized text data into a language encoder and outputting a text embedding vector, and projecting the text embedding vector into an embedding space through a projection head of the language encoder and projecting the modality embedding vector into the embedding space through a projection head of the vision encoder so that the modality embedding vector and the text embedding vector that correspond to each other are matched.

In the generating of the aggregated modality prompt, the aggregated modality prompt may be generated by adding a modality prompt generated at current time step t to the sum of modality prompts generated up to previous time step t−1, and in the generating of the aggregated text prompt, the aggregated text prompt may be generated by adding a text prompt generated at current time step t to the sum of text prompts generated up to previous time step t−1.

In the continual learning method, a loss function may be used, the loss function including a cross-entropy loss for matching the modality embedding vector and the text embedding vector that correspond to each other in the embedding space, a first self-regularization loss for ensuring that the aggregated modality prompt retains previous knowledge, and a second self-regularization loss for ensuring that the aggregated text prompt retains previous knowledge.

The first self-regularization loss may minimize a difference between an aggregated modality prompt at time step t and an aggregated modality prompt at time step t−1, and the second self-regularization loss may minimize a difference between an aggregated text prompt at time step t and an aggregated text prompt at time step t−1.

The loss function may further include a third self-regularization loss for ensuring that the projection head of the vision encoder retains previous knowledge, and the third self-regularization loss may minimize a difference between an aggregated parameter of the projection head of the vision encoder at time step t and an aggregated parameter of the projection head of the vision encoder at time step t−1.

The continual learning method may further include inputting the tokenized multimodality data into the vision encoder to output the modality embedding vector; and inputting the modality embedding vector into a modality classifier such that the modality classifier probabilistically predicts which of previously observed modalities the input modality embedding vector is associated with.

In the generating of the aggregated modality prompt, a predicted probability of the modality classifier may be used as a weight for each modality.

In still another general aspect, there is provided a computing device including a processor and a memory storing one or more programs executed by the processor, in which the processor performs a method for continual learning, and the processor is configured to perform operations including receiving multimodality data including a plurality of data items having different modalities and tokenizing each piece of data, receiving text data representing a class for the multimodality data and tokenizing the text data, generating an aggregated modality prompt for the multimodality data, generating an aggregated text prompt for the text data, inputting modality concatenation data, in which the aggregated modality prompt is concatenated with the tokenized multimodality data, into a vision encoder and outputting a modality embedding vector, inputting text concatenation data in which the aggregated text prompt is concatenated with the tokenized text data into a language encoder and outputting a text embedding vector, and projecting the text embedding vector into an embedding space through a projection head of the language encoder and projecting the modality embedding vector into the embedding space through a projection head of the vision encoder so that the modality embedding vector and the text embedding vector that correspond to each other are matched.

### BRIEF DESCRIPTION OF THE DRAWINGS

FIG. 1 is a configuration diagram of a continual learning device for multimodality data according to an embodiment of the present disclosure.

FIG. 2 is a diagram showing a framework for multimodality continual learning according to an embodiment of the present disclosure.

FIG. 3 is a diagram schematically illustrating a process for identifying and utilizing a related modality using a modality classifier in an embodiment of the present disclosure.

FIG. 4 is a flowchart for describing a continual learning method for multimodality data according to an embodiment of the present disclosure.

FIG. 5 is a block diagram exemplarily illustrating a computing environment that includes a computing device suitable for use in exemplary embodiments.

### DETAILED DESCRIPTION

Hereinafter, specific embodiments of the present disclosure will be described with reference to the accompanying drawings. The following detailed description is provided to assist in a comprehensive understanding of the methods, devices and/or systems described herein. However, the detailed description is only for illustrative purposes and the present disclosure is not limited thereto.

In describing the embodiments of the present disclosure, when it is determined that detailed descriptions of known technology related to the present disclosure may unnecessarily obscure the gist of the present disclosure, the detailed descriptions thereof will be omitted. The terms used below are defined in consideration of functions in the present disclosure, but may be changed depending on the customary practice, the intention of a user or operator, or the like. Thus, the definitions should be determined based on the overall content of the present specification. The terms used in the detailed description are only for describing the embodiments of the present disclosure, and should not be construed as limitative. Unless expressly used otherwise, a singular form includes a plural form. In the present description, the terms “including”, “comprising”, or the like are used to indicate certain characteristics, numbers, steps, operations, elements, and a portion or combination thereof, but should not be interpreted to preclude one or more other characteristics, numbers, steps, operations, elements, and a portion or combination thereof.

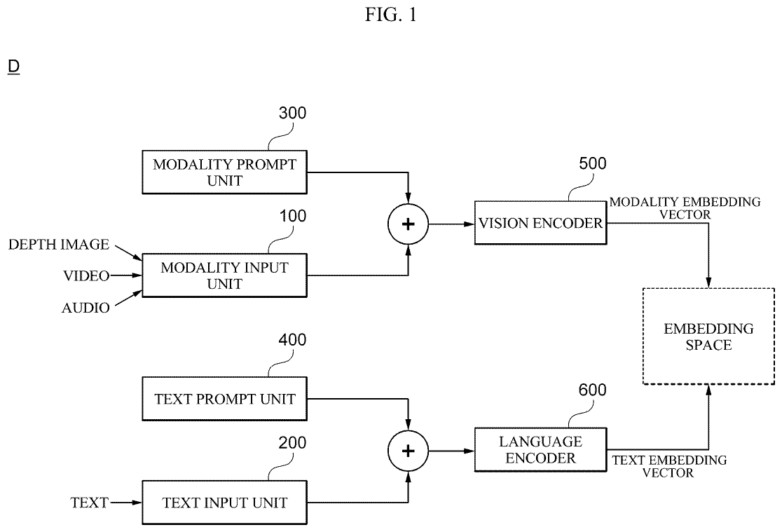

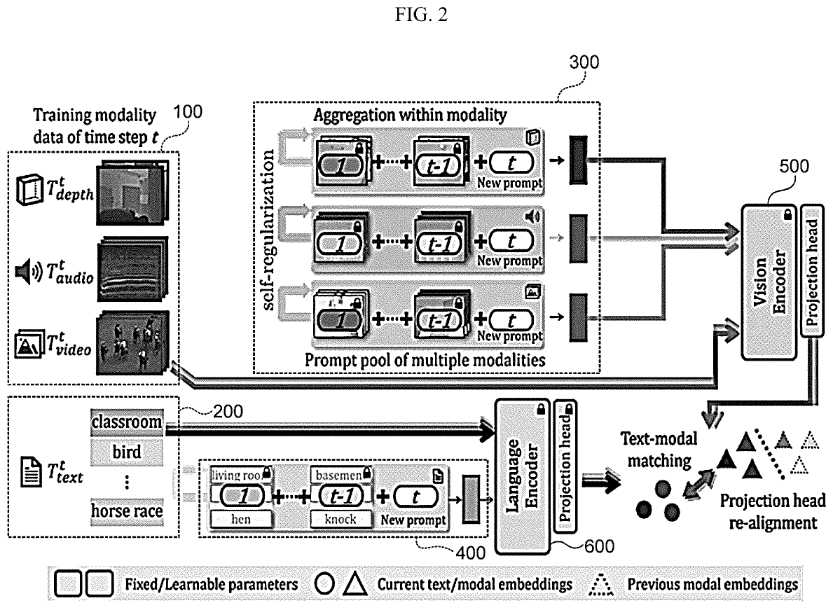

FIG. 1 is a configuration diagram of a continual learning device D for multimodality data according to an embodiment of the present disclosure, and FIG. 2 is a diagram showing a framework for multimodality continual learning according to an embodiment of the present disclosure.

Referring to FIGS. 1 and 2, a modality input unit 100 in the continual learning device D may receive multimodality data including, for example, a depth image, a video, and audio.

That is, the modality input unit 100 may receive a plurality of data items having different modalities. The modality input unit 100 may tokenize each input piece of multimodality data. The modality input unit 100 may tokenize the depth image, the video, and the audio according to a preset method.

A text input unit 200 may receive text data. Here, the text data may be text representing classes of the depth image, the videos, and the audio. The text input unit 200 may tokenize the text data.

A modality prompt unit 300 may generate a modality prompt for each of the depth image, the video, and the audio. The modality prompt unit 300 may generate the modality prompt for each of the depth image, the video, and the audio for each time step.

Here, the prompt may refer to a learnable parameter in a neural network model. The prompt is a separate learnable parameter, other than parameters (inherent parameters) of layers of a neural network model (including a vision encoder 500 and a language encoder 600 in the present disclosure), and in the disclosed embodiment, the prompt is updated without updating the inherent parameters of the neural network model, so that new knowledge is learned while retaining previous knowledge. The modality prompt is a learnable parameter for fine-tuning the vision encoder 500.

The modality prompt unit 300 may generate the modality prompt for each of the depth image, the video, and the audio to train on a new task at time step t. In this case, the modality prompt unit 300 may generate an aggregated modality prompt by adding the modality prompt generated at current time step t to the sum of the modality prompts generated up to previous time step t−1. The aggregated modality prompt

$${\overline{P}}_{m}^{t}$$

may be expressed by Equation 1.

$${\overline{P}}_{m}^{t} = {\sum }_{i = 1}^{t - 1} {P}_{m}^{i} + {P}_{m}^{t} \qquad ( Equation 1 )$$

$${P}_{m}^{t} :$$

Modality prompt for time step t

$${\sum }_{i = 1}^{t - 1} {P}_{m}^{i} :$$

Sum of modality prompts up to previous time step t−1

Here, the aggregated modality prompt for the depth image, the video, and the audio may be concatenated with tokenized multimodality data and input to the vision encoder 500.

A text prompt unit 400 may generate a text prompt for text. The text prompt unit 400 may generate the text prompt for text to train on the new task at time step t. The text prompt is a learnable parameter for fine-tuning the language encoder 600.

In this case, the text prompt unit 400 may generate an aggregated text prompt by adding the text prompt generated at current time step t to the sum of the text prompts generated up to previous time step t−1. The aggregated text prompt

$${\overline{Q}}_{m}^{t}$$

may be expressed by Equation 2.

$${\overline{Q}}_{m}^{t} = {\sum }_{i = 1}^{t - 1} {Q}_{m}^{i} + {Q}_{m}^{t} \qquad ( Equation 2 )$$

$${Q}_{m}^{t} :$$

Text prompt for time step t

$${\sum }_{i = 1}^{t - 1} {Q}_{m}^{i} :$$

Sum of text prompts up to previous time step t−1

Here, the aggregated text prompt for the text may be concatenated with the tokenized text data and input into the language encoder 600.

The vision encoder 500 may receive modality concatenation data, which is data in which the aggregated modality prompt is concatenated with the tokenized multimodality data. The vision encoder 500 may embed the modality concatenation data and output a modality embedding vector.

The language encoder 600 may receive text concatenation data in which the aggregated text prompt is concatenated with the tokenized text data. The language encoder 600 may embed the text concatenation data and output a text embedding vector.

In an embodiment, the vision encoder 500 and the language encoder 600 may be a contrastive language image pre-training (CLIP) model trained on a relationship between images and text. The vision encoder 500 and the language encoder 600 may respectively include projection heads for projecting the modality embedding vector and the text embedding vector into a common embedding space. The modality embedding vectors and text embedding vectors that correspond to each other may be matched in the common embedding space.

In the disclosed embodiment, the continual learning device D may use a cross-entropy loss function so that the modality embedding vector and the text embedding vector correspond to each other (matching). In this case, the continual learning device D may ensure that the aggregated modality prompt and the aggregated text prompt per time step retain previous knowledge. To this end, the continual learning device D may use a loss function including a first self-regularization loss and a second self-regularization loss in addition to the cross-entropy loss. In this case, the loss function

$${ℒ}_{m}^{′}$$

may be expressed by the following Equation 3.

$${ℒ}_{m}^{′} = - {\sum }_{i} {y}_{i}^{t} log p ( {y}_{i}^{t} \vert {x}_{m , i}^{t} ) + {‖ {\overline{P}}_{m}^{t} - {\sum }_{i = 1}^{t - 1} {P}_{m}^{i} ‖}_{2}^{2} + {‖ {\overline{Q}}_{m}^{{}_{t}} - {\sum }_{i = 1}^{t - 1} {Q}_{m}^{i} ‖}_{2}^{2} \qquad ( Equation 3 )$$

Here,

$$- {\sum }_{i} {y}_{i}^{t} log p ( {y}_{i}^{t} \vert {x}_{m , i}^{t} )$$

is the cross-entropy loss. The cross-entropy loss is a loss for properly finding a corresponding pair among the modality embedding vectors and text embedding vectors output from the vision encoder 500 and the language encoder 600, respectively. The cross-entropy loss may be a predefined loss in the CLIP model.

In the cross-entropy loss,

$${y}_{i}^{t}$$

is the correct value at time step t, and

$$p ( {y}_{i}^{t} \vert {x}_{m , i}^{t} )$$

is the predicted probability of the CLIP model at time step t, which may be expressed by the following Equation 4.

$$p ( {y}_{i}^{t} \vert {x}_{m , i}^{t} ) = \frac{exp ( sim ( {v}_{m , i}^{t} , {l}_{text , {y}_{i}^{t}}^{t} ) / τ )}{{\sum }_{j} exp ( sim ( {v}_{m , i}^{t} , {l}_{text , j}^{t} ) / τ )} \qquad ( Equation 4 )$$

$${v}_{m , i}^{t} :$$

i-th modality embedding vector

$${l}_{text , {y}_{i}^{t}}^{t} :$$

Text embedding vector corresponding to

$${v}_{m , i}^{t}$$

$${l}_{text , j}^{t} :$$

Text embedding vectors that do not correspond to

$${l}_{text , j}^{t}$$

τ: Preset temperature parameter

In Equation 3,

$${‖ {\overline{P}}_{m}^{{}_{t}} - {\sum }_{i = 1}^{t - 1} {P}_{m}^{i} ‖}_{2}^{2}$$

is a term representing the first self-regularization loss. Since

$${\overline{P}}_{m}^{t}$$

is the aggregated modality prompt at time step t, and

$${\sum }_{i = 1}^{t - 1} {P}_{m}^{i}$$

is the sum of modality prompts up to previous time step t−1, the first self-regularization loss may be a term for minimizing a difference between the aggregated modality prompt at time step t and the aggregated modality prompt at time step t−1. That is, the first self-regularization loss is intended to ensure that a change in the modality prompt from a previous time step is not large.

In Equation 3,

$${‖ {\overline{Q}}_{m}^{t} - {\sum }_{i = 1}^{t - 1} {Q}_{m}^{i} ‖}_{2}^{2}$$

is a term representing the second self-regularization loss. Since

$${\overline{Q}}_{m}^{t}$$

is the aggregated text prompt at time step t and

$${\sum }_{i = 1}^{t - 1} {Q}_{m}^{t}$$

is the sum of the text prompts up to previous time step t−1, the second self-regularization loss may be a term for minimizing a difference between the aggregated text prompt at time step t and the aggregated text prompt at time step t−1. That is, the second self-regularization loss is intended to ensure that a change in the text prompt from a previous time step is not large.

In addition, the continual learning device D may add a third self-regularization loss to the loss function so that previous knowledge is retained in the projection head of the vision encoder 500. The loss function having the added third self-regularization loss may be expressed as Equation 5.

$${ℒ}_{m}^{″} = - {\sum }_{i} {y}_{i}^{t} log p ( {y}_{i}^{t} \vert {x}_{m , i}^{t} ) + {‖ {\overline{P}}_{m}^{t} - {\sum }_{i = 1}^{t - 1} {P}_{m}^{t} ‖}_{2}^{2} + ‖ {\overline{Q}}_{m}^{t} - {\sum }_{i = 1}^{t - 1} {Q}_{m}^{i} {‖}_{2}^{2} + {‖ {\overline{α}}_{m}^{t} - {\sum }_{i = 1}^{t - 1} {α}_{m}^{i} ‖}_{2}^{2} . \qquad ( Equation 5 )$$

In Equation 5

$${‖ {\overline{α}}_{m}^{t} - {\sum }_{i = 1}^{t - 1} {α}_{m}^{i} ‖}_{2}^{2}$$

is a term representing the third self-regularization loss. Here,

$${\overline{α}}_{m}^{t}$$

is the aggregated parameter of the projection head of the vision encoder 500 at time step t. That is, it may be expressed as

$${\overline{α}}_{m}^{t} = {\sum }_{i = 1}^{t - 1} {α}_{m}^{i} + {α}_{m}^{t} .$$

$${α}_{m}^{i}$$

is the parameter of the projection head at time step t, and

$${\sum }_{i = 1}^{t - 1} {α}_{m}^{i}$$

is the sum of the parameters of the projection head up to previous time step t−1. That is, like the first self-regularization loss and the second self-regularization loss, the third self-regularization loss is intended to retain previous knowledge by ensuring that a change in the parameter in the projection head of the vision encoder 500 from a previous time step is not large.

Meanwhile, in the disclosed embodiment, since prompts of different modalities are used for prompts, the catastrophic forgetting phenomenon occurring when training on prompts of different modalities may be more serious than when using prompts of the same modality. Accordingly, among the modalities observed up to the current time step, it is necessary to be able to identify a new modality (or a modality related to an existing modality). This is to utilize the modality that is associated with a current task among the previously observed modalities.

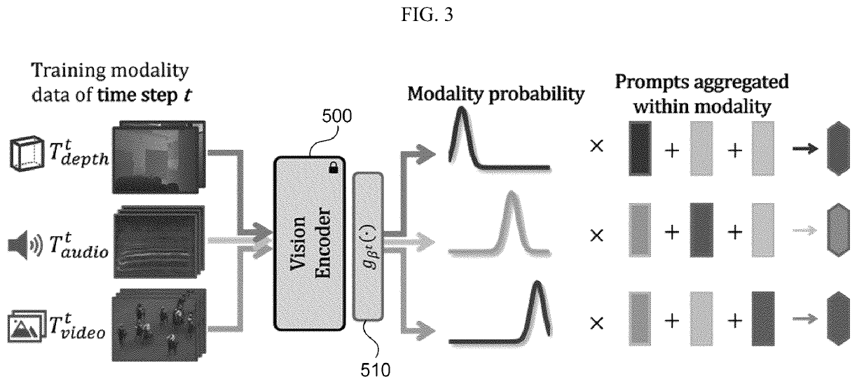

To this end, the continual learning device D may add a modality classifier to an output terminal of the vision encoder 500. FIG. 3 is a diagram schematically illustrating a process for identifying and utilizing a related modality using a modality classifier in an embodiment of the present disclosure.

Referring to FIG. 3, the continual learning device D may input tokenized multimodality data including a depth image, a video, and audio into the vision encoder 500. Then, the vision encoder 500 may embed multimodality data and output a modality embedding vector.

The continual learning device D may input the modality embedding vector output from the vision encoder 500 into a modality classifier 510. In an embodiment, the modality classifier 510 may be a function g_{β}_{^{t}}(⋅) parameterized by β^{t}. The modality classifier 510 may determine which modality each feature belongs to for the input modality embedding vector.

That is, in continual learning, since previous data that does not belong to the modality at current time step t may not be accessed, the modality classifier 510 may be trained to minimize a preset loss function by extracting samples from a normal distribution (that is, a distribution of past modalities) defined by the mean and covariance of previously observed features (the modality embedding vectors). In this case, the modality classifier 510 may calculate the normal distribution defined by the mean and covariance of modality embedding vectors for each modality. The modality classifier 510 may extract samples from the normal distribution of each modality and predict the modality of the extracted samples. The loss function g_{β}_{^{t}}(⋅) for training the modality classifier 510 may be expressed by the following Equation 6.

$${ℒ}_{PA} = {\sum }_{{m}^{′} ∈ {ℳ}^{1 : t}} {\sum }_{i = 1}^{{\overline{n}}_{{m}^{′}}} - log {g}_{{β}^{t}} ( {m}^{′} \vert {\overline{u}}_{{m}^{′}} , i ) \qquad ( Equation 6 )$$

M^{1:t}: Set of all modalities observed up to time step t
m′: Index of a specific modality belonging to the set of modalities observed up to time step t
n̅_{m′}: Number of samples sampled from modality m′
ū_{m′i}: Samples sampled from the normal distribution
g_{β}_{^{t}}(m′|ū_{m′,i}): Probability that the modality classifier predicts that a sample sampled from the normal distribution belongs to modality m′

When trained according to the loss function, the modality classifier 510 may probabilistically estimate which modality a new input feature is most related to when the new input feature comes in. In this case, when generating an aggregated modality prompt, the prompt of the associated modality may be used and the use of the prompt of the non-associated modality may be suppressed.

That is, the aggregated modality prompt may be generated using the predicted probability of the modality classifier 510 (that is, the predicted probability of which of previously observed modalities the input modality is associated with) as a weight. In this case, the aggregated modality prompt P̅_{PA}^{t} generated using the predicted probability of the modality classifier 510 as a weight may be expressed as in Equation 7 below.

$${\overline{P}}_{PA}^{t} = {\sum }_{{m}^{′}} {g}_{{β}^{t}} ( {m}^{′} \vert V ( {e}_{m , i}^{t} ) ) \cdot {\overline{P}}_{{m}^{′}}^{t} \qquad ( Equation 7 )$$

$${V ( {e}_{m , i}^{t} )}_{:}$$

Modality embedding vector output from the vision encoder 500 at time step t

$${e}_{m , i :}^{t}$$

Tokenized multimodality data at time step t

In addition, since learning new knowledge without accessing data of previous tasks may bias modality embeddings toward text embeddings of the latest task, in order to address this, the projection head of the vision encoder 500 may be re-aligned so that old modality embeddings and new modality embeddings are distinguishable. By re-aligning the projection head of the vision encoder 500, biased projection of modality data with respect to recently learned text data may be prevented.

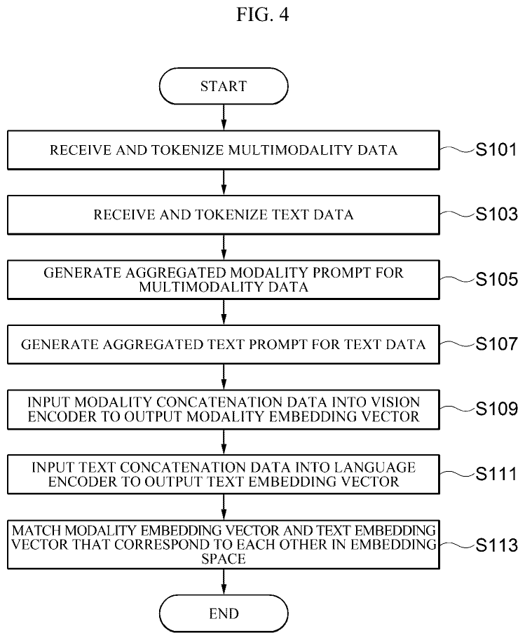

FIG. 4 is a flowchart for describing a continual learning method for multimodality data according to an embodiment of the present disclosure. In the illustrated flowchart, the method is divided into a plurality of steps; however, at least some of the steps may be performed in a different order, performed together in combination with other steps, omitted, performed in subdivided steps, or performed by adding one or more steps not illustrated.

Referring to FIG. 4, the continual learning device D may receive multimodality data, which is a plurality of data items having different modalities, and tokenize each piece of data (S101). Next, the continual learning device D may input text data representing classes for multimodality data and tokenize the text data (S103). Next, the continual learning device D may generate an aggregated modality prompt for the multimodality data (S105) and an aggregated text prompt for the text data (S107).

Next, the continual learning device D may input modality concatenation data in which the aggregated modality prompt is concatenated with the tokenized multimodality data, into the vision encoder to output a modality embedding vector (S109). Next, the continual learning device D may input text concatenation data, which is the aggregated text prompt is concatenated with the tokenized text data, into the language encoder to output a text embedding vector (S111).

Next, the continual learning device D may project the text embedding vector into the embedding space through the projection head of the language encoder, and may project the modality embedding vector into the embedding space through the projection head of the vision encoder so that the modality embedding vector and the text embedding vector that correspond to each other are matched (S113).

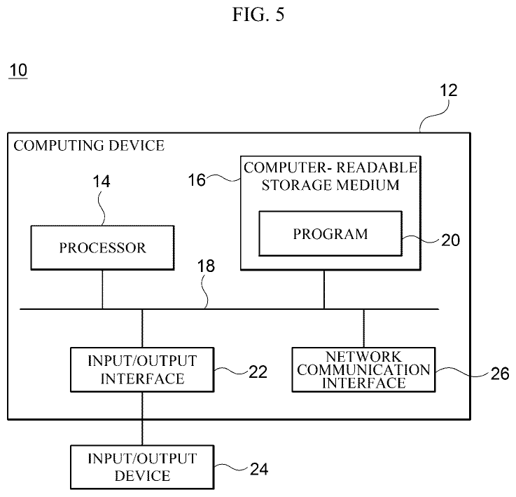

FIG. 5 is a block diagram exemplarily illustrating a computing environment 10 that includes a computing device suitable for use in exemplary embodiments. In the illustrated embodiment, it will be understood by those skilled in the art that each component may have a different function and capability in addition to those described below, and additional components may be included in addition to those described below.

An illustrated computing environment 10 includes a computing device 12. In an embodiment, the computing device 12 may be the continual learning device D.

The computing device 12 includes at least one processor 14, a computer-readable storage medium 16, and a communication bus 18. The processor 14 may cause the computing device 12 to operate according to the above-described exemplary embodiments. For example, the processor 14 may execute one or more programs stored in the computer-readable storage medium 16. The one or more programs may include one or more computer-executable instructions, which may be configured to cause, when executed by the processor 14, the computing device 12 to perform operations according to the exemplary embodiments described above.

The computer-readable storage medium 16 is configured to store computer-executable instructions or program codes, program data, and/or other suitable forms of information. A program 20 stored in the computer-readable storage medium 16 includes a set of instructions executable by the processor 14. In an embodiment, the computer-readable storage medium 16 may be a memory (a volatile memory such as a random-access memory, a non-volatile memory, or any suitable combination thereof), one or more magnetic disk storage devices, optical disc storage devices, flash memory devices, other types of storage media that are accessible by the computing device 12 and may store desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 via the input/output interface 22. The exemplary input/output device 24 may include a pointing device (a mouse, a trackpad, or the like), a keyboard, a touch input device (a touch pad, a touch screen, or the like), a voice or sound input device, input devices such as various types of sensor devices and/or imaging devices, and/or output devices such as a display device, a printer, an interlocutor, and/or a network card. The exemplary input/output device 24 may be included inside the computing device 12 as one of components constituting the computing device 12, or may be connected to the computing device 12 as a separate device distinct from the computing device 12.

According to the disclosed embodiment, it is possible to retain previously learned knowledge by alleviating the catastrophic forgetting phenomenon while training on modality data. In addition, by using prompts, it is possible to fine-tune a pre-trained model by updating only the prompts without updating the entire model. In this case, it is possible to reduce interference between modalities by identifying prompts of modalities associated with each other.

Although the representative embodiments of the present disclosure have been described in detail as above, those skilled in the art will understand that various modifications may be made thereto without departing from the scope of the present disclosure. Therefore, the scope of rights of the present disclosure should not be limited to the described embodiments, but should be defined not only by the claims set forth below but also by equivalents of the claims.

What is claimed is:

1. A continual learning method performed in a computing device including one or more processors and a memory storing one or more programs executed by the one or more processors, the continual learning method comprising:
receiving multimodality data including a plurality of data items having different modalities and tokenizing each piece of data;
receiving text data representing a class for the multimodality data and tokenizing the text data;
generating an aggregated modality prompt for the multimodality data;
generating an aggregated text prompt for the text data;
inputting modality concatenation data, in which the aggregated modality prompt is concatenated with the tokenized multimodality data, into a vision encoder and outputting a modality embedding vector;
inputting text concatenation data in which the aggregated text prompt is concatenated with the tokenized text data into a language encoder and outputting a text embedding vector; and
projecting the text embedding vector into an embedding space through a projection head of the language encoder and projecting the modality embedding vector into the embedding space through a projection head of the vision encoder so that the modality embedding vector and the text embedding vector that correspond to each other are matched.

2. The continual learning method of claim 1, wherein in the generating of the aggregated modality prompt, the aggregated modality prompt is generated by adding a modality prompt generated at current time step t to the sum of modality prompts generated up to previous time step t−1, and
in the generating of the aggregated text prompt, the aggregated text prompt is generated by adding a text prompt generated at current time step t to the sum of text prompts generated up to previous time step t−1.

3. The continual learning method of claim 2, wherein a loss function is used, the loss function including a cross-entropy loss for matching the modality embedding vector and the text embedding vector that correspond to each other in the embedding space, a first self-regularization loss for ensuring that the aggregated modality prompt retains previous knowledge, and a second self-regularization loss for ensuring that the aggregated text prompt retains previous knowledge.

4. The continual learning method of claim 3, wherein the first self-regularization loss minimizes a difference between an aggregated modality prompt at time step t and an aggregated modality prompt at time step t−1, and
the second self-regularization loss minimizes a difference between an aggregated text prompt at time step t and an aggregated text prompt at time step t−1.

5. The continual learning method of claim 3, wherein the loss function further includes a third self-regularization loss for ensuring that the projection head of the vision encoder retains previous knowledge, and
the third self-regularization loss minimizes a difference between an aggregated parameter of the projection head of the vision encoder at time step t and an aggregated parameter of the projection head of the vision encoder at time step t−1.

6. The continual learning method of claim 2, further comprising:
inputting the tokenized multimodality data into the vision encoder to output the modality embedding vector; and
inputting the modality embedding vector into a modality classifier such that the modality classifier probabilistically predicts which of previously observed modalities the input modality embedding vector is associated with.

7. The continual learning method of claim 6, wherein in the generating of the aggregated modality prompt, a predicted probability of the modality classifier is used as a weight for each modality.

8. A computing device comprising:
a processor; and
a memory storing one or more programs executed by the processor,
wherein the processor performs a continual learning method, and
the processor is configured to perform operations comprising:
receiving multimodality data including a plurality of data items having different modalities and tokenizing each piece of data;
receiving text data representing a class for the multimodality data and tokenizing the text data;
generating an aggregated modality prompt for the multimodality data;
generating an aggregated text prompt for the text data;
inputting modality concatenation data, in which the aggregated modality prompt is concatenated with the tokenized multimodality data, into a vision encoder and outputting a modality embedding vector;
inputting text concatenation data in which the aggregated text prompt is concatenated with the tokenized text data into a language encoder and outputting a text embedding vector; and
projecting the text embedding vector into an embedding space through a projection head of the language encoder and projecting the modality embedding vector into the embedding space through a projection head of the vision encoder so that the modality embedding vector and the text embedding vector that correspond to each other are matched.

9. The computing device of claim 8, wherein, in the operation of generating the aggregated modality prompt, the aggregated modality prompt is generated by adding a modality prompt generated at current time step t to the sum of modality prompts generated up to previous time step t−1, and
in the operation of generating the aggregated text prompt, the aggregated text prompt is generated by adding a text prompt generated at current time step t to the sum of text prompts generated up to previous time step t−1.

10. The computing device of claim 9, wherein in the continual learning method, a loss function is used, the loss function including a cross-entropy loss for matching the modality embedding vector and the text embedding vector that correspond to each other in the embedding space, a first self-regularization loss for ensuring that the aggregated modality prompt retains previous knowledge, and a second self-regularization loss for ensuring that the aggregated text prompt retains previous knowledge.

11. The computing device of claim 10, wherein the first self-regularization loss minimizes a difference between an aggregated modality prompt at time step t and an aggregated modality prompt at time step t−1, and
the second self-regularization loss minimizes a difference between an aggregated text prompt at time step t and an aggregated text prompt at time step t−1.

12. The computing device of claim 10, wherein the loss function further includes a third self-regularization loss for ensuring that the projection head of the vision encoder retains previous knowledge, and
the third self-regularization loss minimizes a difference between an aggregated parameter of the projection head of the vision encoder at time step t and an aggregated parameter of the projection head of the vision encoder at time step t−1.

13. The computing device of claim 9, wherein the processor is configured to further perform operations comprising:
inputting the tokenized multimodality data into the vision encoder to output the modality embedding vector; and
inputting the modality embedding vector into a modality classifier such that the modality classifier probabilistically predicts which of previously observed modalities the input modality embedding vector is associated with.

14. The computing device of claim 13, wherein in the operation of generating the aggregated modality prompt, a predicted probability of the modality classifier is used as a weight for each modality.

15. A computer program stored in a non-transitory computer readable storage medium, comprising:
one or more instructions,
wherein the instructions, when executed by a computing device including one or more processors, cause the computing device to perform operations comprising:
receiving multimodality data including a plurality of data items having different modalities and tokenizing each piece of data;
receiving text data representing a class for the multimodality data and tokenizing the text data;
generating an aggregated modality prompt for the multimodality data;
generating an aggregated text prompt for the text data;
inputting modality concatenation data, in which the aggregated modality prompt is concatenated with the tokenized multimodality data, into a vision encoder and outputting a modality embedding vector;
inputting text concatenation data in which the aggregated text prompt is concatenated with the tokenized text data into a language encoder and outputting a text embedding vector; and
projecting the text embedding vector into an embedding space through a projection head of the language encoder and projecting the modality embedding vector into the embedding space through a projection head of the vision encoder so that the modality embedding vector and the text embedding vector that correspond to each other are matched.
